(19) United States
(12) Patent Application Publication
(10) Pub. No.: US 2012/0083221 A1
(43) Pub. Date: Apr. 5, 2012

(54) INTER-FREQUENCY MEASUREMENTS FOR OBSERVED TIME DIFFERENCE OF ARRIVAL

(75) Inventors: Karri M. Ranta-Aho, Espoo (FI); Manivannan Thyagarajan, Coppell, TX (US)

(73) Assignee: Nokia Siemens Networks Oy

(21) Appl. No.: 13/249,814

(22) Filed: Sep. 30, 2011

Related U.S. Application Data
(60) Provisional application No. 61/404,342, filed on Oct. 1, 2010.

(51) Int. Cl. H04B 17/00

(52) U.S. Cl. 455/67.11

(57) ABSTRACT

Aspects of this invention include a method, system and computer program to perform mobile node measurements. In a method there are steps of receiving from a location server at a mobile user node a request to perform inter-frequency reference signal time difference measurements; receiving from a serving access node a measurement gap configuration; performing the requested inter-frequency reference signal time difference measurements during the assigned measurement gaps; and reporting the results of the inter-frequency reference signal time difference measurements to the location server.

### CLAIM OF PRIORITY FROM COPENDING PROVISIONAL PATENT APPLICATION

This patent application claims priority under 35 U.S.C. §119(e) from Provisional Patent Application No. 61/404,342, filed Oct. 1, 2010, the disclosure of which is incorporated by reference herein in its entirety.

### TECHNICAL FIELD

The exemplary and non-limiting embodiments of this invention relate generally to wireless communication systems, methods, devices and computer programs and, more specifically, relate to observed time difference of arrival techniques for positioning a mobile node.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
BS base station
DL downlink (eNB towards UE)
eNB E-UTRAN Node B (evolved Node B)
EPC evolved packet core
E-SMLC evolved/enhanced serving mobile location center
E-UTRAN evolved/enhanced UTRAN (LTE)
IMTA international mobile telecommunications association
ITU-R international telecommunication union-radiocommunication sector
LPP LTE positioning protocol
LPPa LTE positioning protocol A
LTE long term evolution of UTRAN (E-UTRAN)
LTE-A LTE advanced
MAC medium access control (layer 2, L2)
MM/MME mobility management/mobility management entity
NodeB base station
OFDMA orthogonal frequency division multiple access
OTDOA observed time difference of arrival
O&M operations and maintenance
PDCP packet data convergence protocol
PDU protocol data unit
PHY physical (layer 1, L1)
Rel release
RLC radio link control
RRC radio resource control
RRM radio resource management
RSTD reference signal time difference
SFN system frame number
SGW serving gateway
SUPL secure user plane location
SC-FDMA single carrier, frequency division multiple access
UE user equipment, such as a mobile station, mobile node or mobile terminal
UL uplink (UE towards eNB)
UPE user plane entity
UTRAN universal terrestrial radio access network

One modern communication system is known as evolved UTRAN (E-UTRAN, also referred to as UTRAN-LTE or as E-UTRA). In this system the DL access technique is OFDMA, and the UL access technique is SC-FDMA.

One specification of interest is 3GPP TS 36.300, V8.11.0 (2009-12), 3rd Generation Partnership Project; Technical Specification Group Radio Access Network; Evolved Universal Terrestrial Radio Access (E-UTRA) and Evolved Universal Terrestrial Access Network (EUTRAN); Overall description; Stage 2 (Release 8), incorporated by reference herein in its entirety. This system may be referred to for convenience as LTE Rel-8. In general, the set of specifications given generally as 3GPP TS 36.xyz (e.g., 36.211, 36.311, 36.312, etc.) may be seen as describing the Release 8 LTE system. More recently, Release 9 versions of at least some of these specifications have been published including 3GPP TS 36.300, V9.3.0 (2010-03).

FIG. 1 reproduces FIG. 4.1 of 3GPP TS 36.300 V8.11.0, and shows the overall architecture of the EUTRAN system (Rel-8). The E-UTRAN system includes eNBs, providing the E-UTRAN user plane (PDCP/RLC/MAC/PHY) and control plane (RRC) protocol terminations towards the UEs. The eNBs are interconnected with each other by means of an X2 interface. The eNBs are also connected by means of an S1 interface to an EPC, more specifically to a MME by means of a S1 MME interface and to a S-GW by means of a S1 interface (MME/S-GW 4). The S1 interface supports a many-to-many relationship between MMEs/S-GWs/UPEs and eNBs.

The eNB hosts the following functions:
functions for RRM: RRC, Radio Admission Control, Connection Mobility Control, Dynamic allocation of resources to UEs in both UL and DL (scheduling);
IP header compression and encryption of the user data stream;
selection of a MME at UE attachment;
routing of User Plane data towards the EPC (MME/S-GW);
scheduling and transmission of paging messages (originated from the MME);
scheduling and transmission of broadcast information (originated from the MME or O&M); and
a measurement and measurement reporting configuration for mobility and scheduling.

Also of interest herein are further releases of 3GPP LTE (e.g., LIE Rel-10) targeted towards future IMTA systems, referred to herein for convenience simply as LTE-Advanced (LTE-A). Reference in this regard may be made to 3GPP TR 36.913, V9.0.0 (2009-12), 3rd Generation Partnership Project; Technical Specification Group Radio Access Network; Requirements for Further Advancements for E-UTRA (LTE-Advanced) (Release 9). Reference can also be made to 3GPP TR 36.912 V9.2.0 (2010-03) Technical Report 3rd Generation Partnership Project; Technical Specification Group Radio Access Network; Feasibility study for Further Advancements for E-UTRA (LIE-Advanced) (Release 9).

A goal of LTE-A is to provide significantly enhanced services by means of higher data rates and lower latency with reduced cost. LTE-A is directed toward extending and optimizing the 3GPP LTE Rel-8 radio access technologies to provide higher data rates at lower cost. LTE-A will be a more optimized radio system fulfilling the ITU-R requirements for IMT-Advanced while keeping the backward compatibility with LTE Rel-8.

An aspect of LTE and LTE-A is determining a location of a UE. Reference in this regard may be made, for example, to 3GPP TS 36.305 V9.3.0 (2010-06) Technical Specification 3rd Generation Partnership Project; Technical Specification Group Radio Access Network; Evolved Universal Terrestrial Radio Access Network (E-UTRAN); Stage 2 functional specification of User Equipment (UE) positioning in E-UTRAN (Release 9); 3GPP TS 36.355 V9.2.1 (2010-06) Technical Specification 3rd Generation Partnership Project; Technical Specification Group Radio Access Network; Evolved Universal Terrestrial Radio Access (E-UTRA); LTE Positioning Protocol (LPP) (Release 9), and 3GPP TS 36.455 V9.3.0 (2010-09) Technical Specification 3rd Generation Partnership Project; Technical Specification Group Radio Access Network; Evolved Universal Terrestrial Radio Access (E-UTRA); L FE Positioning Protocol A (LPPa) (Release 9). Referring to FIG. 3, an evolved serving mobile location center (E-SMLC) communicates with the UE using LTE positioning protocol (LPP). Over the LPP the E-SMLC is able to provide the UE with information of the cells that the UE is expected to attempt to measure, as well as to receive the OTDOA measurement reports from the UE. The E-SMLC is responsible for the final location calculation based on the UE measurements and a-priori knowledge of the cell geographical locations, as well as their relative transmit timing differences.

FIG. 4 depicts a control plane network architecture for the LPP protocol and the delivery of a LPP protocol data unit (PDU) via the MME and the eNB (control plane signaling flow). FIG. 5 shows a control plane protocol stack for LPP-PDU exchange between the UE and the E-SMLC via the MME and the eNB.

In FIGS. 3, 4 and 5 the server (E-SMLC) provides the UE with a list of potential neighbor cells to search for and measure. The UE then measures and reports the OTDOA for detected neighbor cells. The detection of at least two neighbor cells, in addition to the serving cell (serving eNB) is required for the location (triangulation) calculations.

The UE OTDOA measurements are defined as reference signal time difference (RSTD) measurements. The RSTD measurement of intra-frequency neighbor cells does not require any interaction from the serving cell and, as such, the UE can perform the measurements without impacting the communications link with the serving cell.

However, a problem arises in the LTE Rel-9 extension that defines the RSTD measurements to be applicable also for inter-frequency neighbor cells. The problem that arises relates to the fact that the UE is not expected to be able to measure transmission of a frequency other than that of the serving cell frequency, unless the serving cell explicitly guarantees the UE measurement occasions (measurement gaps) during which it is allowed to tune its receiver momentarily to another frequency for measurement purposes.

Reference with regard to measurement gaps can be made, for example, to 3GPP TS 36.331 V9.3.0 (2010-06) Technical Specification 3rd Generation Partnership Project; Technical Specification Group Radio Access Network; Evolved Universal Terrestrial Radio Access (E-UTRA); Radio Resource Control (RRC); Protocol specification (Release 9), sections 5.5.2.9 “Measurement gap configuration” and 6.3.5 “Measurement information elements”, such as the MeasConfig information element (page 178) and the MeasGapConfig information element (page 179).

As is stated in section 5.5.2.9:

The UE shall:
1> if measGapConfig is set to ‘setup’:
2> if a measurement gap configuration is already setup, release the measurement gap configuration;
2> setup the measurement gap configuration indicated by the measGapConfig in accordance with the received gap Offset, i.e., each gap starts at an SFN and subframe meeting the following condition:

### SFN mod T=FLOOR(gapOffset/10);

subframe=gap Offset mod 10;
with T=MGRP/10 as defined in TS 36.133;
1> else:
2> release the measurement gap configuration.

As per the current Release 9 standard, there is no way for the serving cell to know that the E-SMLC has requested the UE to perform inter-frequency RSTD measurements for OTDOA positioning, and hence the eNB that controls the serving cell is not able to configure the necessary measurement gaps, as needed, for the UE to be able to perform the requested measurements. The eNB controlling the serving cell is thus forced to configure the measurement gap(s) at all times, which is wasteful of system resources.

### SUMMARY

In accordance with a first aspect of the exemplary embodiments of this invention a method comprises receiving from a location server at a mobile user node a request to perform inter-frequency reference signal time difference measurements; receiving from a serving access node a measurement gap configuration; performing the requested inter-frequency reference signal time difference measurements during the assigned measurement gaps; and reporting the results of the inter-frequency reference signal time difference measurements to the location server.

In accordance with another aspect of the exemplary embodiments of this invention an apparatus comprises at least one data processor and at least one memory including computer program code. The memory and computer program code are configured to, with the at least one data processor, cause the apparatus to perform operations to receive from a location server at a mobile user node a request to perform inter-frequency reference signal time difference measurements, to receive from a serving access node a measurement gap configuration, to perform the requested inter-frequency reference signal time difference measurements during the assigned measurement gaps, and to report the results of the inter-frequency reference signal time difference measurements to the location server.

In accordance with another aspect of the exemplary embodiments of this invention an apparatus comprises means for receiving from a location server at a mobile user node a request to perform inter-frequency reference signal time difference measurements; means for receiving from a serving access node a measurement gap configuration; means for performing the requested inter-frequency reference signal time difference measurements during the assigned measurement gaps; and means for reporting the results of the inter-frequency reference signal time difference measurements to the location server.

In accordance with another aspect of the exemplary embodiments of this invention a method comprises receiving signaling that comprises a request to provide a measurement gap configuration for a mobile user node in order for the mobile user node to perform inter-frequency reference signal time difference measurements; providing the measurement gap configuration to the mobile user node in downlink signaling; while the mobile user node performs the requested inter-frequency reference signal time difference measurements, generating the measurement gaps according to the measurement gap configuration; and removing the measurement gap configuration after the mobile user node completes making the inter-frequency reference signal time difference measurements.

In accordance with yet another aspect of the exemplary embodiments of this invention an apparatus comprises at least one data processor and at least one memory including computer program code. The memory and computer program code are configured to, with the at least one data processor, cause the apparatus to perform operations to receive signaling that comprises a request to provide a measurement gap configuration for a mobile user node in order for the mobile user node to perform inter-frequency reference signal time difference measurements; to provide the measurement gap configuration to the mobile user node in downlink signaling; while the mobile user node performs the requested inter-frequency reference signal time difference measurements, to generate the measurement gaps according to the measurement gap configuration; and to remove the measurement gap configuration after the mobile user node completes making the inter-frequency reference signal time difference measurements.

In accordance with a still further aspect of the exemplary embodiments of this invention an apparatus comprises means for receiving signaling that comprises a request to provide a measurement gap configuration for a mobile user node in order for the mobile user node to perform inter-frequency reference signal time difference measurements; means for providing the measurement gap configuration to the mobile user node in downlink signaling; means for generating, while the mobile user node performs the requested inter-frequency reference signal time difference measurements, the measurement gaps according to the measurement gap configuration; and means for removing the measurement gap configuration after the mobile user node completes making the inter-frequency reference signal time difference measurements.

### BRIEF DESCRIPTION OF THE DRAWINGS

In the attached Drawing Figures:

FIG. 1 reproduces FIG. 4.1 of 3GPP TS 36.300, and shows the overall architecture of the EUTRAN system.

FIG. 2 shows a simplified block diagram of various electronic devices that are suitable for use in practicing the exemplary embodiments of this invention.

FIG. 3 is a logical illustration of OTDOA in LTE.

FIG. 4 depicts a control plane network architecture for the LPP protocol.

FIG. 5 shows a control plane protocol stack and various interfaces for LPP-PDU exchange between the UE and the E-SMLC.

FIG. 6 depicts in message flow form a procedure for making inter-frequency reference signal time difference measurements, where the UE to request the eNB to provide measurement gaps.

FIG. 7 depicts in message flow form of a procedure for making inter-frequency reference signal time difference measurements, where the location server (E-SMLC) requests the eNB to provide measurement gaps for the UE.

FIGS. 8 and 9 are each a logic flow diagram that illustrates the operation of a method, and a result of execution of computer program instructions embodied on a computer readable memory, in accordance with the exemplary embodiments of this invention.

### DETAILED DESCRIPTION

It is noted that the foregoing problem would not arise in, for example, a WCDMA system as the cells are statically configured to generate a predetermined pattern of idle periods in the downlink, during which the UE can measure distant cells without interference from the serving cell, or tune its receiver to other frequencies for measurement purposes. Also, the pilot channel that is decoded to perform the measurements is always available for the UE to decode. This conventional approach would, however, translate in the LIE environment as requiring the eNB to configure measurement gaps for all UEs specifically for inter-frequency measurements.

Related to the intra-frequency near-far problem, another solution based on orthogonal reference signals was defined. However, this solution is not compatible with inter-frequency measurements, regardless of whether the UE is making inter-frequency OTDOA measurements.

Thus, the static configuration of measurement gaps would lead to loss of link efficiency at all times for all users, even though the inter-frequency OTDOA measurements are made only very seldom, thus rendering the static measurement gap configuration very inefficient.

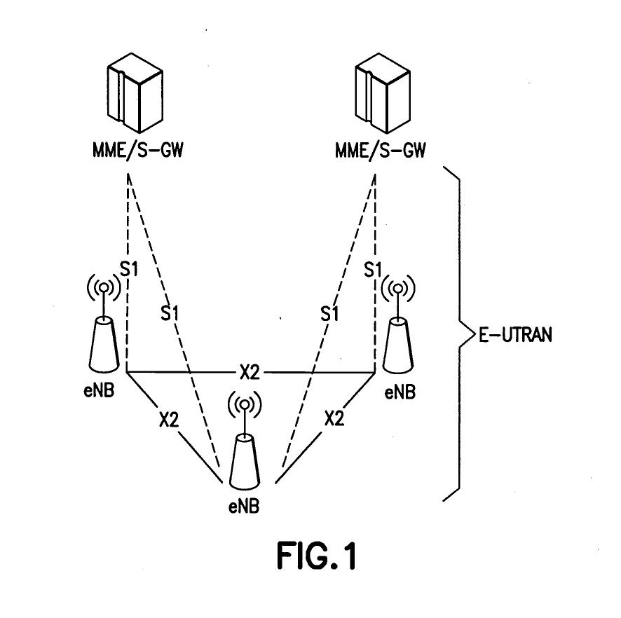

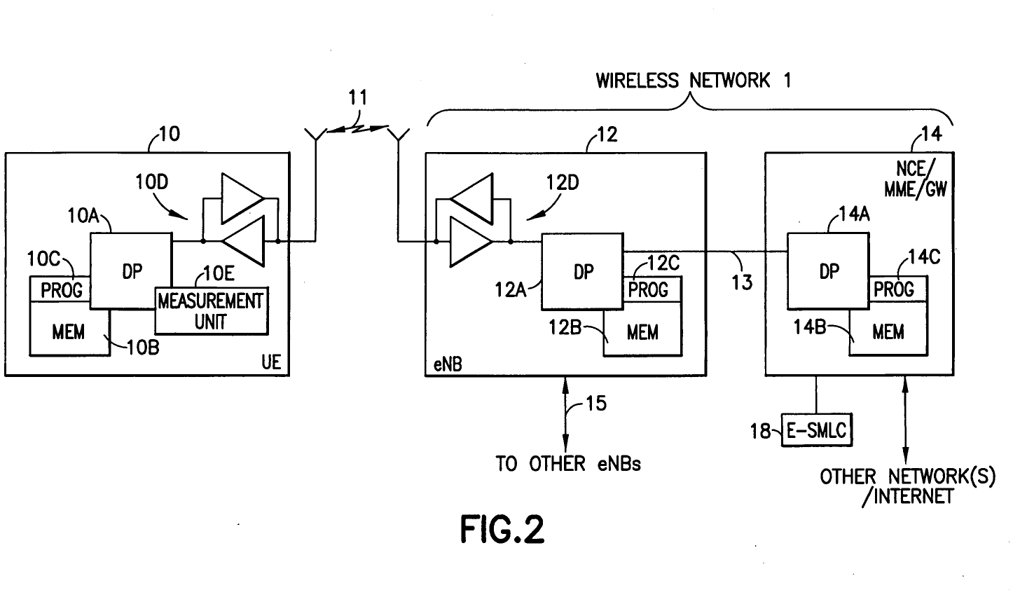

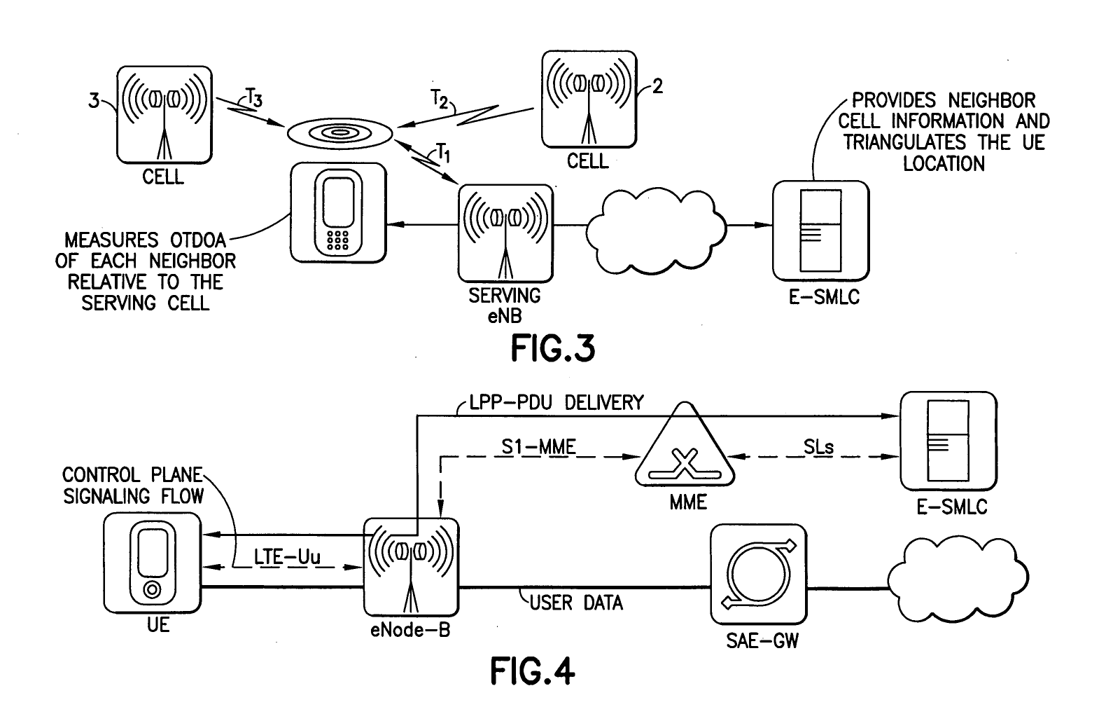

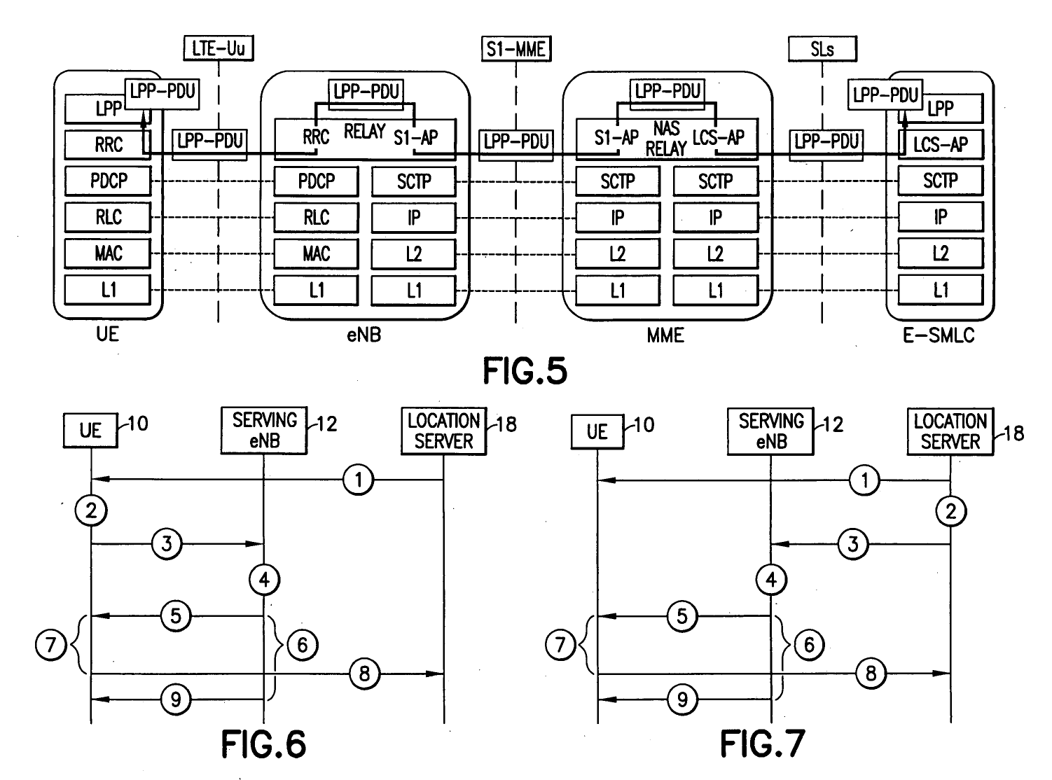

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication over a wireless link 11 with an apparatus, such as a mobile communication device which may be referred to as a UE 10, via a network access node, such as a Node B (base station), and more specifically an eNB 12. The network 1 may include a network control element (NCE) 14 that may include the MME/SGW functionality shown in FIG. 1, and which provides connectivity with a further network, such as a telephone network and/or a data communications network (e.g., the internet). The UE 10 includes a controller, such as at least one computer or a data processor (DP) 10A, at least one non-transitory computer-readable memory medium embodied as a memory (MEM) 10B that stores a program of computer instructions (PROG) 10C, and at least one suitable radio frequency (RF) transmitter/receiver pair (transceiver) 10D for bidirectional wireless communications with the eNB 12 via one or more antennas. The eNB 12 also includes a controller, such as at least one computer or a data processor (DP) 12A, at least one computer-readable memory medium embodied as a memory (MEM) 12B that stores a program of computer instructions (PROG) 12C, and at least one suitable RF transceiver 12D for communication with the UE 10 via one or more antennas (typically several when multiple input/multiple output (MIMO) operation is in use). The eNB 12 is coupled via a data/control path 13 to the NCE 14. The path 13 may be implemented as the S1 interface shown in FIG. 1. The eNB 12 may also be coupled to another eNB via data/control path 15, which may be implemented as the X2 interface shown in FIG. 1.

For the purposes of describing the exemplary embodiments of this invention the UE 10 may be assumed to also include a measurement unit 10E that can be used in cooperation with the receiver to make OTDOA measurements for different neighbor cells, including inter-frequency neighbor cell measurements.

At least one of the PROGs 10C and 12C is assumed to include program instructions that, when executed by the associated DP, enable the device to operate in accordance with the exemplary embodiments of this invention, as will be discussed below in greater detail. That is, the exemplary embodiments of this invention may be implemented at least in part by computer software executable by the DP 10A of the UE 10 and/or by the DP 12A of the eNB 12, or by hardware, or by a combination of software and hardware (and firmware).

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable MEMs 10B and 12B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on multi-core processor architectures, as non-limiting examples.

In accordance with the exemplary embodiments of this invention the eNB 12 is notified of a particular UE 10 being configured for inter-frequency OTDOA, and is thus made aware of the need for measurement gaps for being able to perform the measurements. The eNB 12 is thus able to configure the particular UE with suitable measurement gaps for a predetermined time period, or until informed that the OTDOA measurement procedure has ended.

More specifically, the UE 10 is configured to perform inter-frequency OTDOA measurements using a first protocol (LPP) by the location server (the E-SMLC 18). The eNB 12 is informed that the particular UE 10 is configured to make the inter-frequency OTDOA measurements using a second protocol. The second protocol may be, for example, the RRC protocol over the Uu interface between the UE 10 and the eNB 12 (see FIG. 6), or the LPPa protocol between the eNB 12 and the E-SMLC 18 via the MME 16 (see FIG. 7). The eNB 12 configures the UE 10 with measurement gaps over the RRC protocol layer for some predetermined duration, or until informed by the UE 10 or the E-SMLC 18 that the OTDOA procedure has ended. The value of the predetermined duration may be left to the eNB 12 implementation, or signaling (e.g., RRC or LPPa signaling) can be arranged to inform the eNB 12 of when to remove the measurement gap configuration from the UE 10. If RRC (or LPPa) signaling is used, it is within the scope of the exemplary embodiments to signal the start and stop of inter-frequency measurements to the eNB 12. In any case, the UE 10 measures the inter-frequency RSTD for the inter-frequency cells utilizing the measurement gaps provisioned by the serving eNB 12. The UE 10 then reports the inter-frequency RSTD measurement results to the E-SMLC 18 using the first protocol (LPP).

As was indicated in the previous paragraph, in one exemplary embodiment the UE 10 requests a measurement gap configuration from the eNB 12, while in another exemplary embodiment the E-SMLC 18 informs the eNB 12 of the need for provisioning the UE 10 with the measurement gaps. The first exemplary embodiment, i.e., the UE 10 requesting the measurement gaps from the eNB 12, may be more technically advantageous as it would be readily accommodated by both the control plane and user plane LPP protocol delivery modes, and thus would not require the E-SMLC 18 location server to communicate with the eNB 12 using LPPa signaling. This latter approach may mandate the use of dynamic signaling using LPPa for the OTDOA positioning method/feature, and the creation of dependencies to the LPPa interface when OTDOA positioning is used in the user plane architecture.

Reference is made to FIG. 6 for showing a message flow diagram of a procedure for the UE 10 to request the eNB 12 to provide measurement gaps.

1) The location server (E-SMLC 18) requests, using the LPP protocol, the UE 10 to make inter-frequency RSTD measurements.
2) The UE detects that it is not able to perform the inter-frequency RSTD measurements without being assigned measurement gaps.
3) Using the RRC protocol the UE 10 indicates to the eNB 12 that it needs to perform inter-frequency RSTD measurements and needs measurement gaps to be assigned.
4) The eNB 12 determines to provide the UE 10 with measurement gaps.
5) The eNB 12 provides the UE 10 with a measurement gap configuration using the RRC protocol.
6) The eNB 12 generates the measurement gaps according to the provided configuration.
7) The UE 10 measures the inter-frequency RSTD during the assigned measurement gaps.
8) The UE 10 reports the inter-frequency RSTD measurement results to the location server (E-SMLC 18) using the LPP protocol.
9) The eNB 12 removes the measurement gap configuration from the UE 10 using the RRC protocol.

Reference is now made to FIG. 7 for showing a message flow diagram of a procedure for the E-SMLC 18 to request the eNB 12 to provide measurement gaps for the UE 10. It can be noted that steps 2 and 3 differ from the steps 2 and 3 of the procedure shown in FIG. 6.

1) The location server (E-SMLC 18) requests, using the LPP protocol, the UE 10 to make inter-frequency RSTD measurements.
2) The location server (E-SMLC 18) determines that the UE 12 is not able to perform the inter-frequency RSTD measurements without measurement gaps. This determination can be based on UE 10 capability acquired earlier.
3) Using a network protocol (LPPa) the location server (E-SMLC 18) indicates to the eNB 12 that a particular UE 10 needs to perform inter-frequency RSTD measurements and needs measurement gaps to be assigned in order to perform the measurements.
4) The eNB 12 determines to provide the UE 10 with measurement gaps.
5) The eNB 12 provides the UE 10 with a measurement gap configuration using the RRC protocol.
6) The eNB 12 generates the measurement gaps according to the provided configuration.
7) The UE 10 measures the inter-frequency RSTD during the assigned measurement gaps.
8) The UE 10 reports the inter-frequency RSTD measurement results to the location server (E-SMLC 18) using the LPP protocol.
9) The eNB 12 removes the measurement gap configuration from the UE 10 using the RRC protocol.

Note that some of these steps and the resulting message flows could be in a different order than those shown. For example, the order of steps 1 and 2 of FIG. 7 could be reversed.

Based on the foregoing it should be apparent that the exemplary embodiments of this invention provide methods, apparatus and computer program(s) to facilitate the making of inter-frequency RSTD measurements by the UE 10.

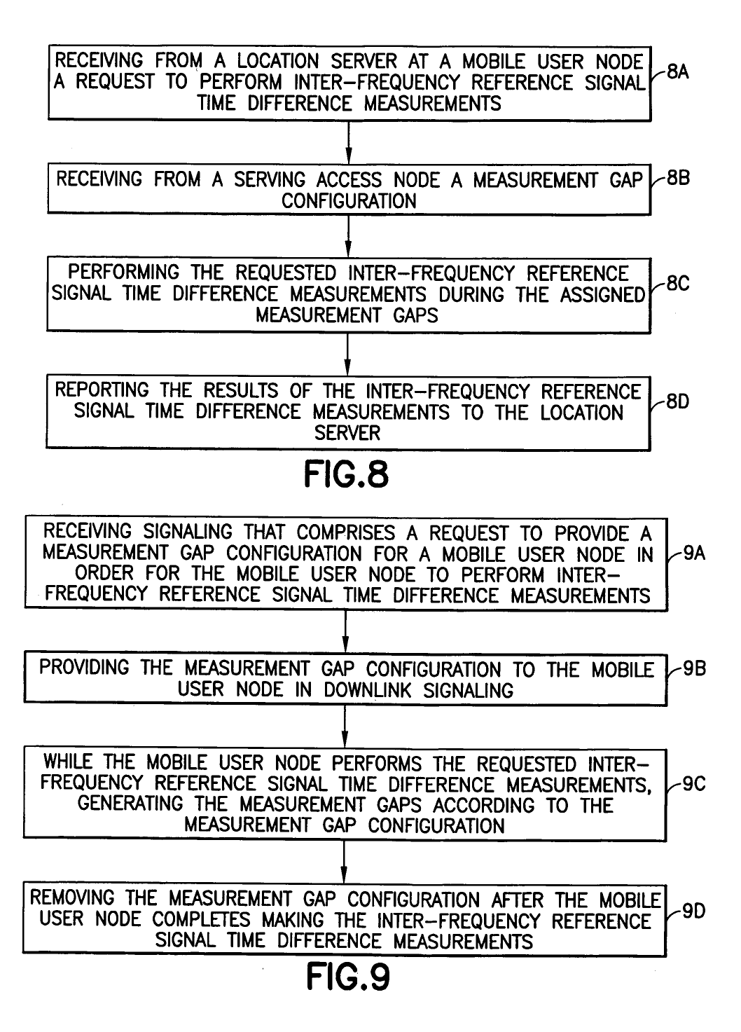

FIG. 8 is a logic flow diagram that illustrates the operation of a method, and a result of execution of computer program instructions, in accordance with the exemplary embodiments of this invention. In accordance with these exemplary embodiments, and from the perspective of a mobile user node, a method performs, at Block 8A, a step of receiving from a location server at the mobile user node a request to perform inter-frequency reference signal time difference measurements. At Block 8B there is a step of receiving from a serving access node a measurement gap configuration. At Block 8C there is a step of performing the requested inter-frequency reference signal time difference measurements during the assigned measurement gaps. At Block 8D there is a step of reporting the results of the inter-frequency reference signal time difference measurements to the location server.

In the method of FIG. 8, where the step performed in Block 8B comprises a preliminary step of the mobile user node requesting the serving access node to assign the measurement gap configuration.

In the method of the preceding paragraph, where the mobile user node requests the serving access node to assign the measurement gap configuration using radio resource control signaling.

In the method of FIG. 8, where the step performed in Block 8B comprises a preliminary step of the location server requesting the serving access node to assign the measurement gap configuration.

In the method of the preceding paragraph, where the location server requests the serving access node to assign the measurement gap configuration using long term evolution positioning protocol A (LPPa) signaling.

The exemplary embodiments also encompass a non-transitory computer-readable medium that contains software program instructions, where execution of the software program instructions by at least one data processor results in performance of operations that comprise execution of the method of FIG. 8 and the foregoing several paragraphs.

The various blocks shown in FIG. 8 may be viewed as method steps, and/or as operations that result from operation of computer program code, and/or as a plurality of coupled logic circuit elements constructed to carry out the associated function(s).

Also disclosed is an apparatus that comprises at least one processor and at least one memory including computer program code, where the memory and computer program code are configured to, with the at least one processor, cause the apparatus to receive from a location server at a mobile user node a request to perform inter-frequency reference signal time difference measurements, to receive from a serving access node a measurement gap configuration, to perform the requested inter-frequency reference signal time difference measurements during the assigned measurement gaps, and to report the results of the inter-frequency reference signal time difference measurements to the location server.

In the apparatus the operation that receives the measurement gap configuration is preceded by an operation where the data processor requests, using RRC signaling, the serving access node to assign the measurement gap configuration.

In the apparatus the operation that receives the measurement gap configuration is preceded by an operation where the location server requests, using LPPa signaling, the serving access node to assign the measurement gap configuration.

The exemplary embodiments also pertain to an apparatus that comprises means for receiving (e.g., receiver of transceiver 10D, DP 10A, program 10C) from a location server at a mobile user node a request to perform inter-frequency reference signal time difference measurements; means for receiving (e.g., receiver of transceiver 10D, DP 10A, program 10C) from a serving access node a measurement gap configuration; means for performing the requested inter-frequency reference signal time difference measurements (e.g., measurement unit 10E) during the assigned measurement gaps; and means for reporting (e.g., transmitter of transceiver 10D, DP 10A, program 10C) the results of the inter-frequency reference signal time difference measurements to the location server.

The means for receiving from the serving access node the measurement gap configuration operates in cooperation for means for requesting the serving access node to assign the measurement gap configuration using radio resource control signaling.

The means for receiving from the serving access node the measurement gap configuration can also operate in cooperation with the location server requesting the serving access node to assign the measurement gap configuration using long term evolution positioning protocol A (LPPa) signaling.

FIG. 9 is a logic flow diagram that illustrates the operation of a method, and a result of execution of computer program instructions, further in accordance with the exemplary embodiments of this invention. In accordance with these exemplary embodiments, and from the perspective of an access node that serves a mobile user node, a method performs, at Block 9A, a step of receiving signaling that comprises a request to provide a measurement gap configuration for the mobile user node in order for the mobile user node to perform inter-frequency reference signal time difference measurements. At Block 9B there is a step of providing the measurement gap configuration to the mobile user node in downlink signaling. At Block 9C there is a step performed, while the mobile user node performs the requested inter-frequency reference signal time difference measurements, of generating the measurement gaps according to the measurement gap configuration. At Block 9D there is a step of removing the measurement gap configuration after the mobile user node completes making the inter-frequency reference signal time difference measurements.

In the method of FIG. 9, where the signaling received in Block 9A comprises signaling received from the mobile user node requesting the serving access node to assign the measurement gap configuration.

In the method of the preceding paragraph, where the mobile user node requests the serving access node to assign the measurement gap configuration using radio resource control signaling.

In the method of FIG. 9, where the signaling received in Block 9A comprises signaling received from a location server, that instructed the mobile user node to perform the inter-frequency reference signal time difference measurements, where the received signaling requests the serving access node to assign the measurement gap configuration.

In the method of the preceding paragraph, where the location server requests the serving access node to assign the measurement gap configuration using long term evolution positioning protocol A (LPPa) signaling.

The exemplary embodiments also encompass a non-transitory computer-readable medium that contains software program instructions, where execution of the software program instructions by at least one data processor results in performance of operations that comprise execution of the method of FIG. 9 and the foregoing several paragraphs.

The various blocks shown in FIG. 9 may be viewed as method steps, and/or as operations that result from operation of computer program code, and/or as a plurality of coupled logic circuit elements constructed to carry out the associated function(s).

Also disclosed is an apparatus that comprises at least one processor and at least one memory including computer program code, where the memory and computer program code are configured to, with the at least one processor, cause the apparatus to receive signaling that comprises a request to provide a measurement gap configuration for a mobile user node in order for the mobile user node to perform inter-frequency reference signal time difference measurements; to provide the measurement gap configuration to the mobile user node in downlink signaling, while the mobile user node performs the requested inter-frequency reference signal time difference measurements; to generate the measurement gaps according to the measurement gap configuration; and to remove the measurement gap configuration after the mobile user node completes making the inter-frequency reference signal time difference measurements.

In one embodiment of the apparatus the signaling that is received comprises radio resource control signaling from the mobile user node for requesting the apparatus to assign the measurement gap configuration, while in another embodiment the signaling that is received comprises long term evolution positioning protocol A (LPPa) signaling from a location server for requesting the apparatus to assign the measurement gap configuration, where the location server is one that instructs the mobile user node to perform the inter-frequency reference signal time difference measurements.

Also disclosed is an apparatus that comprises means for receiving (e.g., receiver of transceiver 12D, DP 12A, program 12C) signaling that comprises a request to provide a measurement gap configuration for a mobile user node in order for the mobile user node to perform inter-frequency reference signal time difference measurements; means for providing (e.g., transmitter of transceiver 12D, DP 12A, program 12C) the measurement gap configuration to the mobile user node in downlink signaling; means for generating (e.g., DP 12A, program 12C), while the mobile user node performs the requested inter-frequency reference signal time difference measurements, the measurement gaps according to the measurement gap configuration; and means for removing (e.g., DP 12A, program 12C) the measurement gap configuration after the mobile user node completes making the inter-frequency reference signal time difference measurements.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the UTRAN LTE and LTE-A systems, it should be appreciated that the exemplary embodiments of this invention are not limited for use with only these particular types of wireless communication system, and that they may be used to advantage in other wireless communication systems where a user equipment needs at least one measurement gap assigned in order to perform inter-frequency location determination-related measurements.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described interfaces, protocols and measurement types (e.g., RRC, LPP, RSTD, etc.) are not intended to be limiting in any respect, as these interfaces, protocols and measurement types may be identified by any suitable names. Further, the various names assigned to different network elements (e.g., eNB, MME, E-SMLC) are not intended to be limiting in any respect, as these various network elements may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
receiving from a location server at a mobile user node a request to perform inter-frequency reference signal time difference measurements;
receiving from a serving access node a measurement gap configuration;
performing the requested inter-frequency reference signal time difference measurements during the assigned measurement gaps; and
reporting the results of the inter-frequency reference signal time difference measurements to the location server.

2. The method of claim 1, where receiving from the serving access node the measurement gap configuration comprises a preliminary step of the mobile user node requesting the serving access node to assign the measurement gap configuration.

3. The method of claim 2, where the mobile user node requests the serving access node to assign the measurement gap configuration using radio resource control signaling.

4. The method of claim 1, where receiving from the serving access node the measurement gap configuration comprises a preliminary step of the location server requesting the serving access node to assign the measurement gap configuration.

5. The method of claim 4, where the location server requests the serving access node to assign the measurement gap configuration using long term evolution positioning protocol A (LPPa) signaling.

6. A non-transitory computer-readable medium that contains software program instructions, where execution of the software program instructions by at least one data processor results in performance of operations that comprise execution of the method of claim 1.

7. An apparatus, comprising:
at least one data processor and at least one memory including computer program code, where the memory and computer program code are configured to, with the at least one data processor, cause the apparatus to perform operations to receive from a location server at a mobile user node a request to perform inter-frequency reference signal time difference measurements, to receive from a serving access node a measurement gap configuration, to perform the requested inter-frequency reference signal time difference measurements during the assigned measurement gaps, and to report the results of the inter-frequency reference signal time difference measurements to the location server.

8. The apparatus of claim 7, where an operation that receives the measurement gap configuration is preceded by an operation where the data processor requests, using radio resource control signaling, the serving access node to assign the measurement gap configuration.

9. The apparatus of claim 7, where an operation that receives the measurement gap configuration is preceded by an operation where the location server requests, using long term evolution positioning protocol A (LPPa) signaling, the serving access node to assign the measurement gap configuration.

10.-12. (canceled)

13. A method, comprising:
receiving signaling that comprises a request to provide a measurement gap configuration for a mobile user node in order for the mobile user node to perform inter-frequency reference signal time difference measurements;
providing the measurement gap configuration to the mobile user node in downlink signaling;
while the mobile user node performs the requested inter-frequency reference signal time difference measurements, generating the measurement gaps according to the measurement gap configuration; and
removing the measurement gap configuration after the mobile user node completes making the inter-frequency reference signal time difference measurements.

14. The method of claim 13, where the received signaling comprises signaling received from the mobile user node requesting a serving access node to assign the measurement gap configuration.

15. The method of claim 14, where the received signaling is radio resource control signaling.

16. The method of claim 13, where the received signaling comprises signaling received from a location server that instructed the mobile user node to perform the inter-frequency reference signal time difference measurements, where the received signaling requests a serving access node to assign the measurement gap configuration.

17. The method of claim 16, the serving access node is requested to assign the measurement gap configuration using long term evolution positioning protocol A (LPPa) signaling.

18. A non-transitory computer-readable medium that contains software program instructions, where execution of the software program instructions by at least one data processor results in performance of operations that comprise execution of the method of claim 13.

19. An apparatus, comprising:
at least one data processor and at least one memory including computer program code, where the memory and computer program code are configured to, with the at least one data processor, cause the apparatus to perform operations to receive signaling that comprises a request to provide a measurement gap configuration for a mobile user node in order for the mobile user node to perform inter-frequency reference signal time difference measurements; to provide the measurement gap configuration to the mobile user node in downlink signaling; while the mobile user node performs the requested inter-frequency reference signal time difference measurements, to generate the measurement gaps according to the measurement gap configuration; and to remove the measurement gap configuration after the mobile user node completes making the inter-frequency reference signal time difference measurements.

20. The apparatus of claim 19, embodied in a serving access node, where the received signaling comprises signaling received from the mobile user node requesting the serving access node to assign the measurement gap configuration.

21. The apparatus of claim 20, where the received signaling is radio resource control signaling.

22. The apparatus of claim 19, embodied in a serving access node, where the received signaling comprises signaling received from a location server that instructed the mobile user node to perform the inter-frequency reference signal time difference measurements, where the received signaling requests the serving access node to assign the measurement gap configuration.

23. The apparatus of claim 22, where the serving access node is requested to assign the measurement gap configuration using long term evolution positioning protocol A (LPPa) signaling.

24.-26. (canceled)
